(19) United States
(12) Patent Application Publication
(10) Pub. No.: US 2025/0067370 A1
(43) Pub. Date: Feb. 27, 2025

(54) PAIRED AND INTERCONNECTED COUNTER-WOUND COILED HOSES

(71) Applicant: Mark W. Gardner, Wasola, MO (US)

(72) Inventor: Mark W. Gardner, Wasola, MO (US)

(21) Appl. No.: 18/810,385

(22) Filed: Aug. 20, 2024

Related U.S. Application Data
(60) Provisional application No. 63/520,711, filed on Aug. 21, 2023.

(51) Int. Cl. F16L 11/12; F16L 11/22; F16L 57/02

(52) U.S. Cl. CPC F16L 11/12; F16L 11/22; F16L 57/02

(57) ABSTRACT

A paired set of elongated lines or hoses, in which each line comprises an elastic portion having a series of serially-connected counter-wound coils. One line's coils are wound in a clockwise rotation, while the other line's coils are wound in a counter-clockwise rotation. One line is positioned longitudinally inside the other. The lines are bound together by a plurality of ties positioned at crossing sites where the coils from one line engage the coils from the other line.

### CROSS REFERENCE TO RELATED APPLICATIONS

This application derives and claims priority from U.S. provisional application 63/520,711, filed Aug. 21, 2023, and having Attorney Docket No. 1580-2, which provisional application is incorporated herein by reference.

### STATEMENT REGARDING FEDERALLY SPONSORED RESEARCH OR DEVELOPMENT

Not applicable.

### BACKGROUND OF THE INVENTION

This invention relates principally to coiled line or hose handling and/or management (such as for example, the handling of air hoses for compressed air driven power tools), and more particularly to the configuration of two or more flexible and/or elastic coiled lines or hoses paired together in a particular orientation to prevent, or at least minimize, the potential for one of such lines to knot and/or bind.

It has for some time been a standard practice to use flexible and/or elastic coiled hoses for a variety of applications, where such lines and hoses may be constructed of various elastic and/or pliant materials that include, for example, rubber, plastic and various metals. The applications include, for example, coiled compressed air hoses, coiled pneumatic lines and fluid supply lines. Such lines and hoses provide a convenient and generally reliable extension for the distribution of a fluid, such as compressed gases and pneumatic oils in such applications. The use of coiled lines and hoses in these applications can enable a user to conveniently and rapidly reach locations with the desired fluid, and quickly maneuver from one location to another without having to relocate the source of the fluid.

For example, a carpenter may attach a pneumatic nail gun (or any of a variety of other pneumatic carpentry tools) to one end of a coiled compressed air hose, and the other end to an air compressor. The carpenter can then utilize the pressurized air supplied by the air compressor to operate the nail gun (or any other pneumatic carpentry tool) at a variety of locations about the air compressor, limited only by the length of the air hose when fully extended—all without having to move the air compressor.

By way of another example, a water nozzle can be attached to one end of a coiled retractable garden hose and the opposite end attached to a water spigot valve. When the spigot valve is opened, the water nozzle can be used to dispense water from virtually any position within the radius defined by the length of the hose when fully extended from the spigot valve—all without having to connect the hose to a different water source.

Unfortunately, the convenience afforded by such lines and hoses suffers considerably when the coiled and elastic nature of the lines and hoses causes them to twist, tangle and knot up. That is, it is a well-recognized and time-wasting problem—and an irritation—that traditional elastic and/or pliant coiled lines and hoses are universally prone to tangle and knot-up when collapsed after being extended. This tangling and knotting-up can require substantial time to clear and untangle or “un-knot”, and can even cause damage to, or ruin, the hose due to crimping during the collapse or mishandling when attempting to untangle.

It would therefore be desirable to have an elastic and/or pliant coiled hose that is configured in such a way that it would be less prone to twisting, tangling and/lor knotting-up than traditional coiled lines and hoses. As will become evident in this disclosure, the present invention provides such benefits over the existing art.

### BRIEF DESCRIPTION OF THE DRAWINGS

The illustrative embodiments of the present invention are shown in the following drawings which form a part of the specification:

FIG. 1 is a perspective view of a representative first embodiment of the present invention, having two closely-sized coiled hoses with uniformly-spaced coils which are counter-wound with respect to each other and attached to each other at various cross points by plastic ties, the inner hose being positioned along a length within the outer hose;

FIG. 2 is a side elevation of FIG. 1 in which the hoses have been extended longitudinally;

FIG. 3 is a cross-sectional end view of FIG. 1, showing that the outer diameter of the inner coiled hose is approximately the same and the inner diameter of the outer coiled hose;

FIG. 4 is a perspective view of an individual loop from each of the hoses of FIG. 1, depicted in isolation and juxtaposed relative to each other;

FIG. 5 is a perspective view of the coiled hoses of FIG. 1 collectively bowed around an obstacle;

FIG. 6 is a top view of the coiled hoses of FIG. 6;

FIG. 7 is a plan view of the coiled hoses of FIG. 6;

FIG. 8 is a side elevation view of a representative alternative embodiment of the present invention, having two dissimilarly-sized coiled hoses with uniformly-spaced coils which are counter-wound with respect to each other and attached to each other at various cross points by plastic ties, the inner hose being substantially smaller in diameter than the outer hose and positioned along a length within the outer hose;

FIG. 9 is a cross-sectional end view of FIG. 8, showing that the outer diameter of the inner coiled hose is substantially smaller than inner diameter of the outer coiled hose;

FIG. 10 is a side elevation view of a second representative alternative embodiment of the present invention, having two closely-sized coiled hoses with nonuniformly-spaced coils which are counter-wound with respect to each other and attached to each other at various cross points by plastic ties, the inner hose being positioned along a length within the outer hose and having fewer coils per unit length than the outer hose;

FIG. 11 is a side elevation view of a third representative alternative embodiment of the present invention, having two closely-sized coiled hoses with nonuniformly-spaced coils which are counter-wound with respect to each other and attached to each other at various cross points by plastic ties, the inner hose being positioned along a length within the outer hose and having more coils per unit length than the outer hose;

Corresponding reference characters indicate corresponding parts throughout the several views of the drawings.

### DETAILED DESCRIPTION

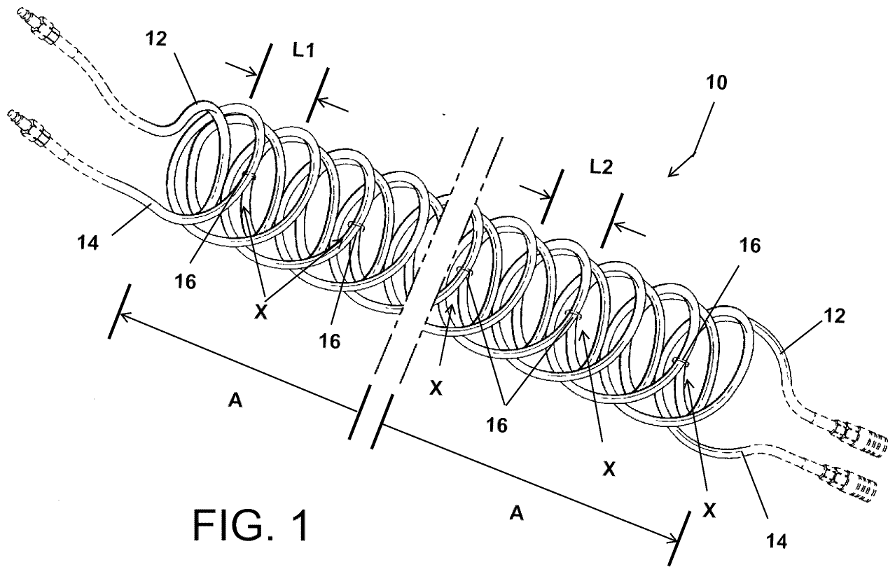

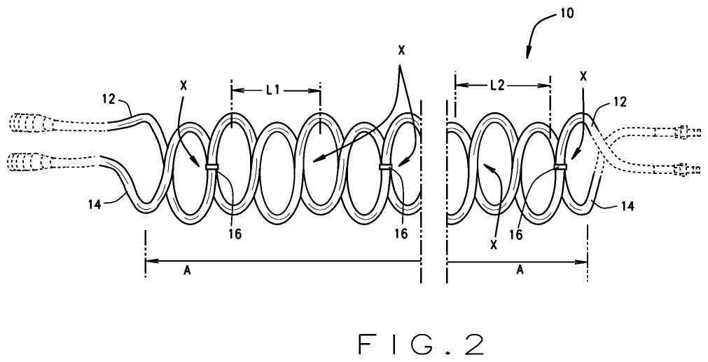

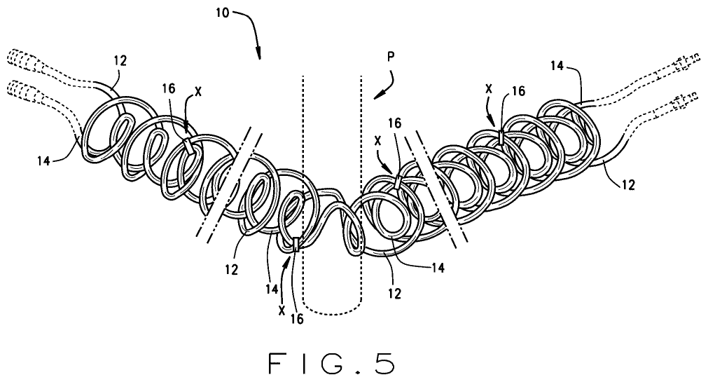

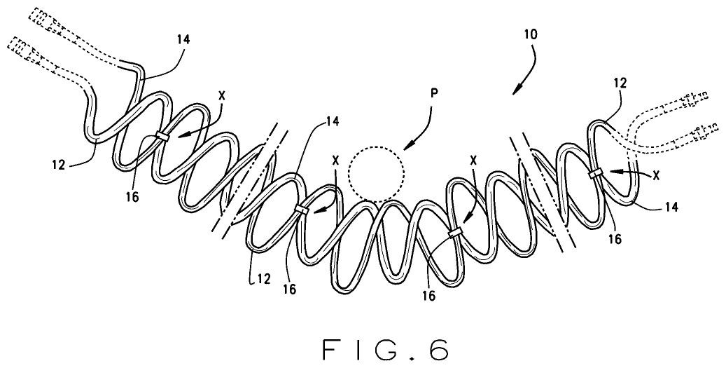

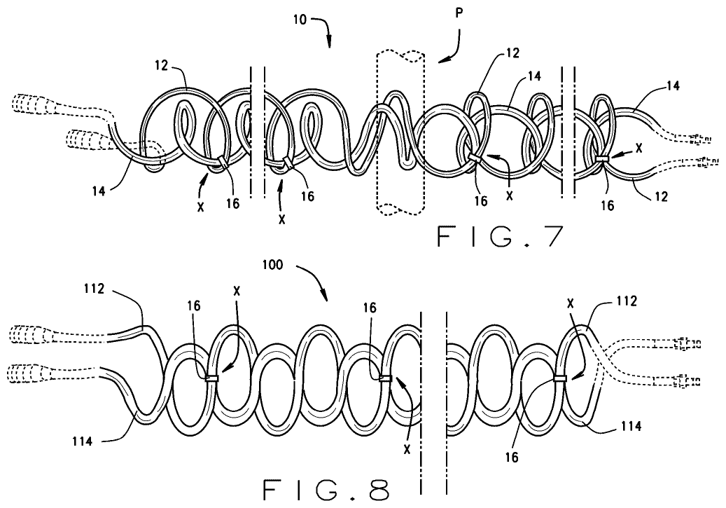

In referring to the drawings, a representative embodiment of a set 10 of paired and interconnected counter-wound coiled hoses is of the present invention is depicted by way of example in FIGS. 1-8. The representative set 10 includes a hollow outer coiled hose 12, and a hollow inner coiled hose 14, and a plurality of ties 16 that attach the hose 12 to the hose 14.

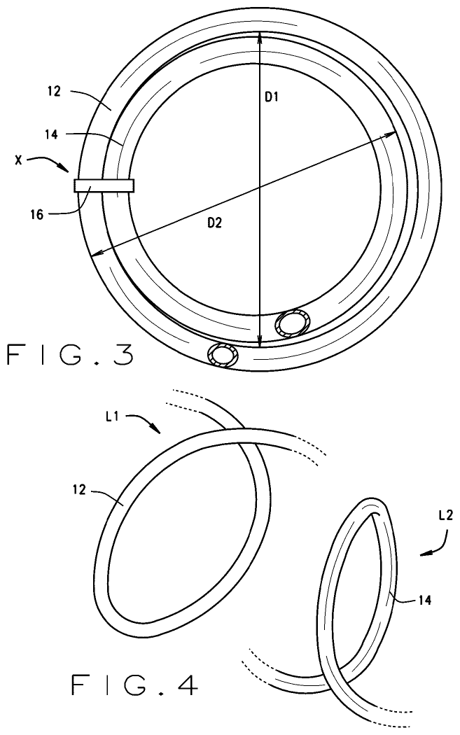

Referring to FIGS. 1-3, it can be seen that the outer coiled hose 12 is pre-shaped along a length A with a series of generally uniformly-spaced coiled loops L1. Referring particularly to FIG. 3, it is seen that each of the loops L1 has a generally uniform inner diameter D1. The outer coiled hose 12 comprises an elastic material (such as for example, a hybrid blend of polyurethane, PVC and rubber that is sometimes used for air compressor hoses) throughout the length A that allows the hose 12 to be stretched, pulled and twisted in various directions to a limited degree without damaging the hose. Further, the elasticity of the hose 12 material also creates a bias or tension in the hose 12 that urges the hose 12 to retract to its original or resting configuration when not being stretched, pulled or twisted.

Referring again to FIGS. 1-3, the inner coiled hose 14, much like the outer coiled hose 12, is pre-shaped along the same length A (corresponding to the outer coiled hose 12) with a series of generally uniformly-spaced coiled loops L2. Referring particularly to FIG. 3, it is seen that each of the loops L2 has a generally uniform outer diameter D2 having a size that is slightly less that the inner diameter D1 of hose 12 so that the coils of hose 14 can fit within the coils of hose 12 as depicted in FIGS. 1-3. The inner coiled hose 14 comprises an elastic material throughout the length A (such as for example, a hybrid blend of polyurethane, PVC and rubber that is sometimes used for air compressor hoses) that allows the hose 14 to be stretched, pulled and twisted in various directions to a limited degree without damaging the hose. Further, the elasticity of the hose 14 material also creates a bias or tension in the hose 14 that urges the hose 14 to retract to its original or resting configuration when not being stretched, pulled or twisted.

Referring again to FIGS. 1-3, it can be seen that the outer coiled hose 12 is wound along the length A in a counter-clockwise rotation, while the inner coiled hose 14 is wound along the length A in a clockwise rotation. Thus, the outer coiled hose 12 is “counter-wound” with regard to the inner coiled hose 14. In this way, at generally uniform sites X along the length A, the outer coiled hose 12 crosses over and briefly engages the inner coiled hose 14. The sites X occur approximately once per set of paired loops L1 and L2. That is, along each pair of matching loops L1 and L2, the outer coiled hose 12 crosses over the inner coiled loop 14 to create a site X. The number of sites X for a particular set 10 the paired and interconnected counter-wound coiled hoses 12 and 14 will therefore vary depending on the number of paired loops L1 and L2 in the set 10 along the length A.

As seen in FIG. 1, the representative set 10 also includes a plurality of ties 16 to attach and hold the coils 12 and 14 together. Each of the ties 16 attaches the outer hose 12 to the inner hose 14 at one of the cross point sites X where a portion or length of the outer hose 12 “crosses” and engages a portion or length of the inner hose 14. In this embodiment 10, the ties 16 comprise plastic “zip tie” clips that have been tightened to hold the hoses 12 and 14 together.

As one of ordinary skill in the art will appreciate, and as utilized in this invention by the Applicant, the counter-wound orientation of the hoses 12 and 14 results in an “X”-shaped interface between the hoses 12 and 14 at each site X. This shape of the set 10 will tend to immobilize the clips 16 in the center of the “X” for each site X and prevent the clips 16 from shifting their positions or moving along either the hose 12 or the hose 14 to any great extent. Thus, while the clips 16 may shift slightly longitudinally when the set 10 is elongated, twisted or moved about, clips 16 will move little because the sites X will remain generally in the same relative positions and the clips 16 are secured snugly about the hoses 12 and 14 at the sites X.

Applicant has found, and as can be further appreciated by one of ordinary skill in the art, due to the unique counter-winding and secure tying of the lines together, such for example with regard to the hoses 12 and 14 of the set 10, the lines of each set will tend not to bind, tangle or knot-up, even when the set has been stretched or elongated and then released. The set will simply return to its untangled collapsed state or condition.

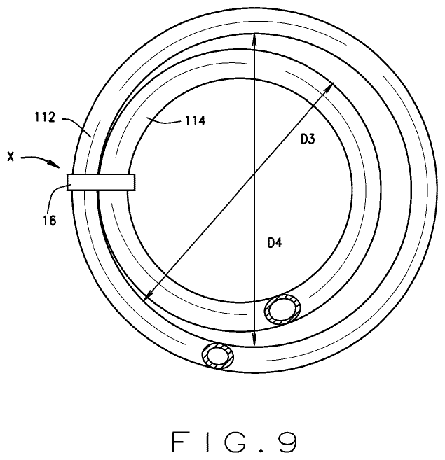

FIGS. 8-11 depict three alternate embodiments of the present invention. FIGS. 8 and 9 depict an embodiment of a paired set in which the first line or tube 112 has a series of interconnected uniform circular coils with an inner diameter D4 that is substantially greater than the outer diameter D3 of the series of interconnected uniform circular coils of the inner line or tube 114.

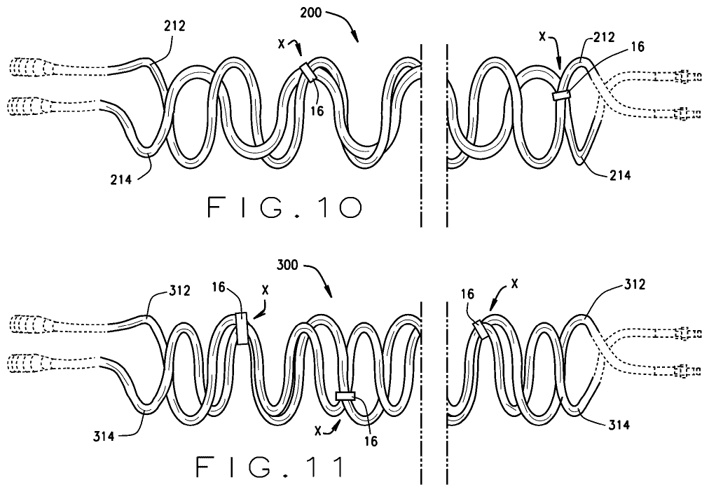

FIG. 10 depicts a paired set of lines or hoses in which the outer line 212 has more individual coils or loops per unit length than the inner line 214, along the coiled lengths of the lines 212 and 214.

FIG. 11 depicts a paired set of lines or hoses in which the outer line 312 has fewer individual coils or loops per unit length than the inner line 314, along the coiled lengths of the lines 312 and 314.

While I have described in the detailed description a configuration that may be encompassed within the disclosed embodiments of this invention, numerous other alternative configurations, that would now be apparent to one of ordinary skill in the art, may be designed and constructed within the bounds of my invention as set forth in the claims. Moreover, the above-described novel set 10 of paired and interconnected counter-wound coiled hoses of the present invention can be arranged in a number of other and related varieties of configurations without expanding beyond the scope of our invention as set forth in the claims.

By way of example, the lines for each paired set are not limited to those types and configurations of lines as depicted in the drawings. Rather, the lines for the sets, such as the sets 10, 100, 200 or 300, can be hoses (such as for example, the hoses 12 and 14), pipes, tubes, or any other such elongated elastic or resilient product, so long as the lines can be retractably coiled and can two or more can be attached in a manner the same as or similar to that disclosed herein. Similarly, the lines can have various degrees of elasticity, and need not have the same degree of elasticity as between each of the lines in a set 10. Further, the degree of elasticity may vary along the length of the line. Of course, any one or more of the lines in a set may be constructed of any variety of elastic and/or resilient materials (including for example, various plastics, metals, alloys, fibers, etc.), so long as the lines and the set can be configured to provide the benefits as described herein.

Moreover, the lines may have differing cross-sectional diameters, as between lines in a set 10, and can have differing cross-sectional shapes and diameters along the length of the individual lines (e.g., oval, square, rectangular, hexagonal, octagonal, irregular). In addition, it is not necessary that any of the lines in a set be hollow. Thus, any one or more of the lines in a set may be partially and/or fully solid throughout the length of the line.

Although it is preferable that inner diameter of outer line approximates outer diameter of inner line as shown in FIGS. 1-7, the inner diameter of the outer line can be greater or less than the outer diameter of the inner line (see, e.g., FIGS. 8 and 9) so long as the inner and outer lines are “counter-wound” and the inner line can be attached at multiple points to the outer line along the length A.

Additionally, the outer and inner paired lines can have a different number of coils or loops per unit length along the joined length A. (See, e.g., FIGS. 10 and 11).

By way of further example, the line loops for each paired set are not limited to those orientations and configurations of lines as depicted in the drawings. Rather, the loops can have various cross-sectional shapes (e.g., oval, square, rectangular, hexagonal, octagonal, irregular).

In addition, Applicant's unique paired and interconnected counter-wound coiled line set invention is not limited to only two lines. Rather, each set may have three or more lines, so long as at least two of the lines are “counter-wound” and directly or indirectly attached to each other.

As a further example, the number, orientation and/or positioning, and types of ties used to attach the lines together in a paired set are not limited in configuration to those depicted in the Figures. Rather: (i) the ties may be oriented and/or positioned along the lines in a set in any of a variety of orientations and locations (including uniformly-spaced and non-uniformly-spaced); and (iii) any of a variety of types of ties may be used (including for example, metal or plastic clips or clamps, cinches, clasps, fasteners, brackets, plastic or metal or fiber or textile ropes, threads, or twines or wires) instead of the plastic zip-ties 16 shown in the Figures; so long as the number, orientation/position and/or types of ties adequately secures the lines together in each paired set so as to provide the benefits discussed in this disclosure. For example, the ties 16 can be positioned at all of the cross-sites X, or just some.

In yet a further example, the ties 16 can be configured to pivot, rotate, twist or spin about an axis positioned between the tie's connections to the two lines or hoses 12 and 14, to thereby provide a smoother action between the lines 12 and 14 when the lines are longitudinally extended or retracted. The ties 16 can also be configured to elastically stretch or elongate between the tie's connections to the two lines or hoses 12 and 14.

It is also recognized by the Applicant that the lines or hoses 12 and 14 (and by extension the lines or hoses 112 and 114, 212 and 214, and 312 and 314) can be conjoined to form a single line or hose. That is, the lines or hoses 12 and 14 (and by extension the lines or hoses 112 and 114, 212 and 214, and 312 and 314) can actually be two sections of a single line or hose, or two lines or hoses spliced together. Thus, for example, the lines 12 and 14 can be joined at either end (or both ends) of the length A, or anywhere along the length A (and similar configurations can be constructed or formed for the lines or hoses 112 and 114, 212 and 214, and 312 and 314).

Additional variations or modifications to the configuration of the above-described novel scrap metal furnace evaporative cooling system 100 for a metal recycle furnace 10 of the present invention may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of our invention.

What is claimed is:

1. A paired set of interconnected counter-wound coiled lines, said paired set comprising:
a. a first line, said first line having an elastic portion, said portion comprising a collection of serially connected coils forming a first series, said first series of coils being wound in a clockwise rotation;
b. a second line, said second line having an elastic portion, said portion comprising a collection of serially connected coils forming a second series, said second series of coils being wound in a counter-clockwise rotation;
c. a plurality of ties, each of said ties being adapted to secure said first line to said second line;
wherein said second series of coils is longitudinally positioned within said first series of coils, said first series of coils periodically engaging said second series of coils at a plurality of crossing sites, and each of said plurality of ties secures said first line to said second line at one of said plurality of crossing sites.

2. The paired set of claim 1, wherein one of said first line elastic portion and said second line elastic portion comprises a hose, a pipe, and a tube.

3. The paired set of claim 1, wherein at least a portion of one of said first line elastic portion and said second line elastic portion comprises a cross-sectional shape that is one of a circle, an oval, a rectangle, a square, a hexagon, an octagon, a triangle.

4. The paired set of claim 1, wherein one of said first line elastic portion and said second line elastic portion comprises at least in part a solid core.

5. The paired set of claim 1, wherein at least a portion of one of said first line elastic portion coils has a different cross-sectional shape than one other of said first line elastic portion coils.

6. The paired set of claim 1, wherein at least a portion of one of said first line elastic portion coils has a different cross-sectional shape than of said second line elastic portion coils.

7. The paired set of claim 6, wherein said first line elastic portion comprises a plurality of coils having substantially uniform circular loops.

8. The paired set of claim 7, wherein said second line elastic portion comprises a plurality of coils having substantially uniform circular loops.

9. The paired set of claim 7, wherein said plurality of said first series of coils has an inner diameter that is one of: (a) greater than the outer diameter of said plurality of said second series of coils; and (b) less than the outer diameter of said plurality of said second series of coils.

10. The paired set of claim 1, wherein the number of coils in said first line elastic portion equals the number of coils in said second line elastic portion.

11. The paired set of claim 1, wherein one of said plurality of ties comprises one of a pivot between the first and second lines, a clip, a clamp, a piece of rope or twine or thread or wire, chain, a cinch, a clasp, a fastener, and a bracket.

12. A paired set of interconnected counter-wound coiled lines, said set comprising:
a. an elastic outer line, said outer line comprising a plurality of generally circular coils, said plurality of coils being serially connected to form an outer series, all of said plurality of coils having a substantially uniform inner diameter, said outer series of coils being wound in one of a clockwise or counter-clockwise rotation;
b. an elastic inner line, said inner line comprising a plurality of generally circular coils, said plurality of coils being serially connected to form an inner series, all of said plurality of coils having a substantially uniform outer diameter, said inner series outer diameter being less than said outer series inner diameter, said inner series of coils being wound in the other of a clockwise or counter-clockwise rotation, said inner series of coils being longitudinally positioned inside said outer series of coils, said inner series of coils periodically engaging said outer series of coils at a plurality of crossing sites;
c. a plurality of ties, each of said ties securing said inner line to said outer line at one of said plurality of crossing sites.

13. The paired set of claim 12, wherein one of said first line elastic portion and said second line elastic portion comprises a hose, a pipe, and a tube.

14. The paired set of claim 12, wherein at least a portion of one of said first line elastic portion and said second line elastic portion comprises a cross-sectional shape that is one of a circle, an oval, a rectangle, a square, a hexagon, an octagon, a triangle.

15. The paired set of claim 12, wherein one of said first line elastic portion and said second line elastic portion comprises at least in part a solid core.

16. The paired set of claim 12, wherein at least a portion of one of said first line elastic portion coils has a different cross-sectional shape than one other of said first line elastic portion coils.

17. The paired set of claim 12, wherein at least a portion of one of said first line elastic portion coils has a different cross-sectional shape than of said second line elastic portion coils.

18. The paired set of claim 17, wherein said plurality of said first series of coils has an inner diameter that is one of: (a) slightly greater than the outer diameter of said plurality of said second series of coils; and (b) substantially less than the outer diameter of said plurality of said second series of coils.

19. The paired set of claim 12, wherein the number of coils in said first line elastic portion equals the number of coils in said second line elastic portion.

20. The paired set of claim 12, wherein one of said plurality of ties comprises one of a pivot between the outer and inner lines, a clip, a clamp, a piece of rope or twine or thread or wire, chain, a cinch, a clasp, a fastener, and a bracket.
